(19) United States
(12) Patent Application Publication
(10) Pub. No.: US 2015/0048564 A1
(43) Pub. Date: Feb. 19, 2015

(54) METHOD FOR TURNING OVER A LARGE-SIZED OR HEAVY PART

(71) Applicants: Joel Archer, Nantes (FR); Olivier Sevrin, Cosne Sur Loire (FR)

(72) Inventors: Joel Archer, Nantes (FR); Olivier Sevrin, Cosne Sur Loire (FR)

(73) Assignee: SOCIETE D'APPLICATIONS ELECTRIQUES ET MECANIQUES - SAPEM, Le Mesnil Le Roi (FR)

(21) Appl. No.: 14/384,524

(22) PCT Filed: Mar. 5, 2013
(86) PCT No.: PCT/FR2013/050467

§ 371 Date: Sep. 11, 2014

(30) Foreign Application Priority Data
Mar. 12, 2012 (FR) 1252177
Mar. 4, 2013 (FR) 1351902

(51) Int. Cl. B66F 7/22; B25H 1/10

(52) U.S. Cl. CPC B66F 7/22; B25H 1/10
USPC 269/58

(57) ABSTRACT

A device (1) for turning over, in particular, a part (100), includes two towers (3) opposite one another, each tower including: a stationary portion (4) and a portion (5) that is vertically movable relative to the stationary portion; an actuator element (16) for moving the movable portion relative to the stationary portion; a beam (6) movable about a stationary axis (X6) relative to the movable portion, the beam including at least one arm; and a ball (8) for retaining the arm at the stationary portion, wherein the part (100) is attached to the beams (6).

The present invention relates to a turning device, in particular for a large or heavy piece that cannot be manipulated by hand, in particular to a turning/positioning device for performing painting, sanding, shot blasting and/or washing operations, on such a piece.

Many problems must be solved by a machine for manipulating such a piece, in particular,

Accessibility and ergonomics:
the areas of the piece that are to be treated, for example the areas to be painted, must be accessible:
the position of the operator must be ergonomic;
Accessibility and ergonomics improve the quality—this quality may be a safety factor. This is the case with train bogies, which are particularly bulky and heavy pieces (several hundreds of kg), which must be painted on the entire surface thereof; this protection guarantees long life for the bogies, and therefore train safety.

Environment:

The machine must be able to withstand:
an explosive atmosphere. When solvents are present, the machine must therefore be able to meet the ATEX standards on explosive atmospheres;
an aggressive atmosphere, in particular with shot during shot blasting; and
a corrosive atmosphere, in particular during washing

Safety:
the machine must ensure safety in all phases of use, and in particular provide a safe working position and a safe movement of personnel and in particular the operator; and
environmental risks.

Logistics:
the machine must be able to be integrated in a logistic chain, for work in a flow, without handling means, which implies a source of energy.

Maintenance reduced to a minimum.

Economy:
the cost of owning the machine must be as low as possible.

Several types of lifting/positioning machine are known, in particular:
pure hoists, such as those used in car garages. They require work under the load, which poses safety problems;
pure machines for positioning in rotation;
those that offer lifting and rotation independent of each other.

Such lifting/positioning machines generally use actuation means of the hydraulic jack type, telescopic or not, or screw racks.

Hydraulic jacks use a hydraulic unit and an electric motor. They have major drawbacks:
they are sensitive to environmental conditions and present in particular a risk of rapid destruction of the seals by dust, for example coming from the shot blasting of the parts;
they do not withstand any lateral force and therefore pose a problem of guidance of the rods; and
the bulk thereof, even retracted, is very great and greater than the stroke.

Conventional pneumatic jacks with a rod, other than those mentioned for hydraulic jacks, pose specific problems:
they are not available with long strokes; and
they are very expensive since they are special.

The aim of the invention is to propose a turning device solving all or some of the problems of the devices in the prior art, meeting in particular the requirements of reliability and safety.

To achieve its aim, the invention proposes a turning device, in particular for a piece, characterised in that it comprises at least one tower, preferably two towers facing each other, each tower comprising:
a fixed part and a part able to move vertically relative the fixed part;
jack means for moving said movable part relative to said fixed part;
a beam able to move about a fixed pivot axis relative to said movable part, said beam comprising at least one arm; and
means for holding said arm, preferably in a releasable fashion, on the fixed part, at a distance horizontally from said pivot axis;
   said piece being fixed to the beams.

The jack means advantageously comprise a bellows jack that can be disposed under the movable part.

The beam may comprise two arms extending substantially opposite each other and, preferably, holding means particular to each arm.

The holding means preferentially comprise a link articulated on the fixed part. The device advantageously comprises pin means for connecting and articulating the link removably with the corresponding arm. The pin may comprise elastic means, preferably an elastomer cylinder surrounding a metal core.

The device according to the invention may further comprise means for moving and holding the part in vertical translation, each arm being released from the holding means. Thus it may comprise a guide and means of engagement between the beam and the guide at a distance from the pivot axis, the guide comprising an oblong window for the vertical guidance of the engagement means.

Several embodiments of the invention will be described below, by way of non-limitative examples, with reference to the accompanying drawings, in which:

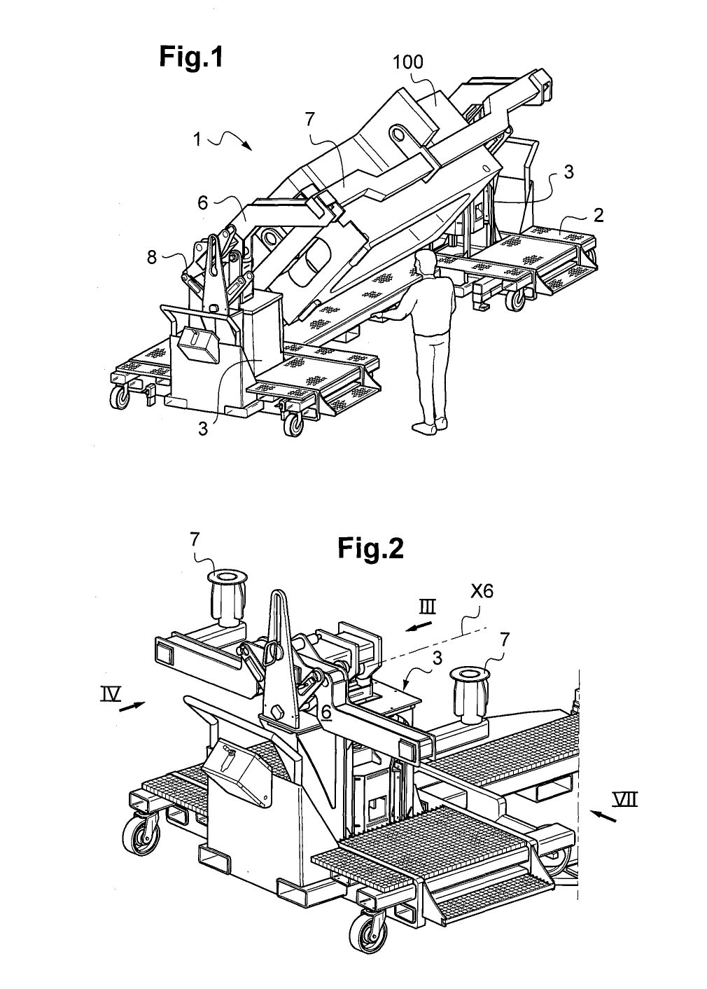

FIG. 1 is a schematic view in front three-quarter perspective of a turning device according to the invention;

FIG. 2 is a schematic view in front three-quarter perspective of a column, the left-hand one, and its beam for the turning device in FIG. 1;

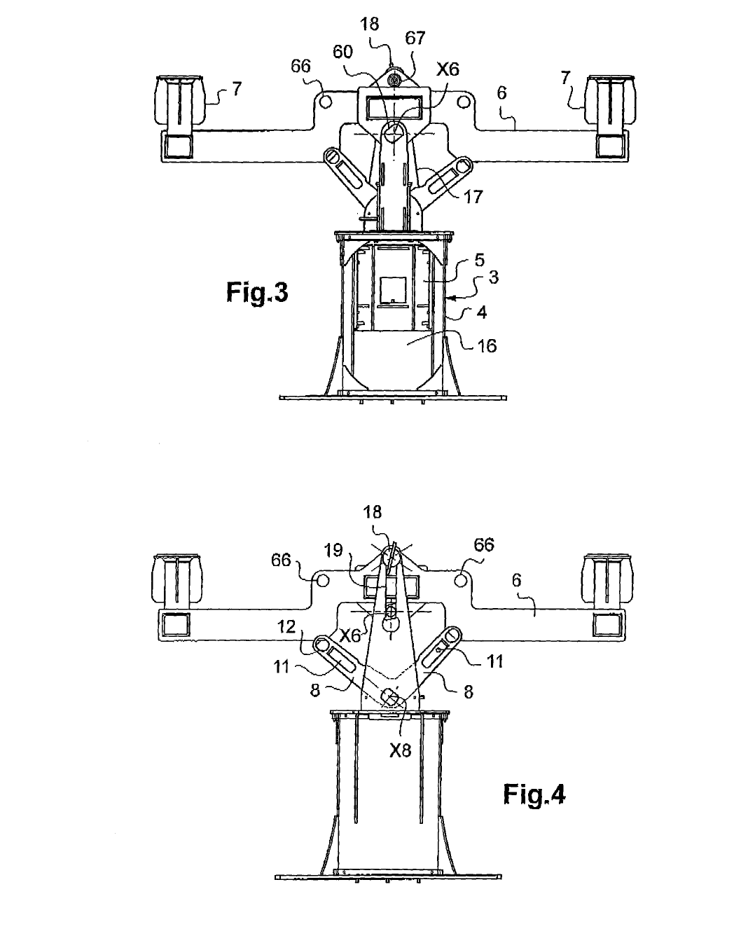

FIG. 3 is a right-hand view, in the direction III, of the column in FIG. 2, with the beam horizontal;

FIG. 4 is a left-hand view, in the direction IV, of the column in FIG. 2, with the beam horizontal;

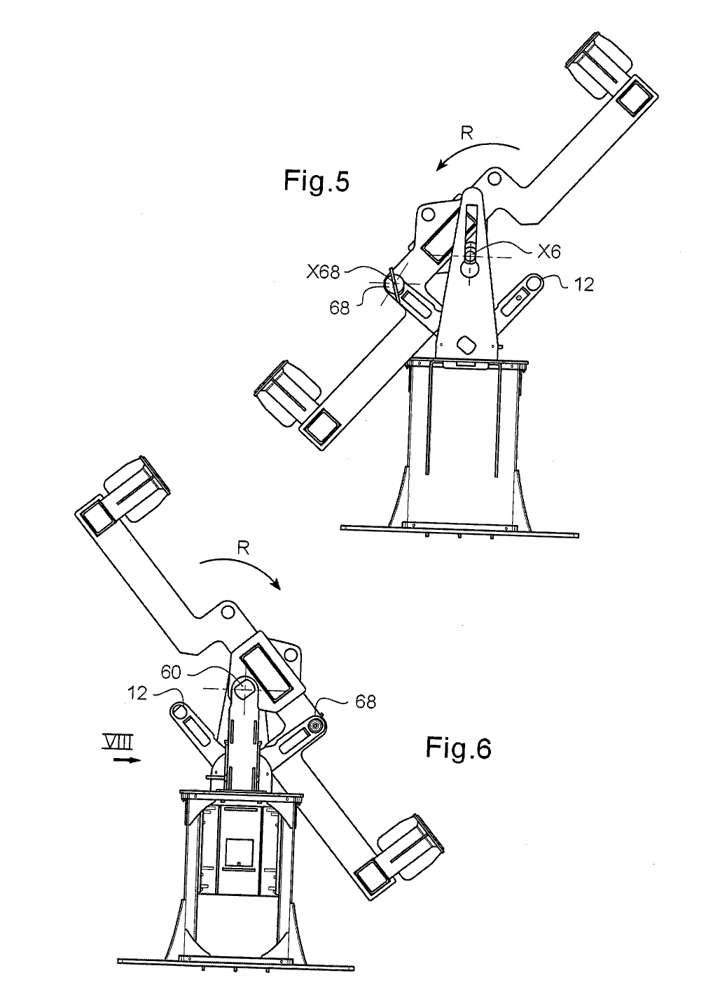

FIG. 5 is a left-hand view, in the direction IV, of the column in FIG. 2, with the beam tilted;

FIG. 6 is a right-hand view, in the direction III, of the column in FIG. 2, with the beam tilted;

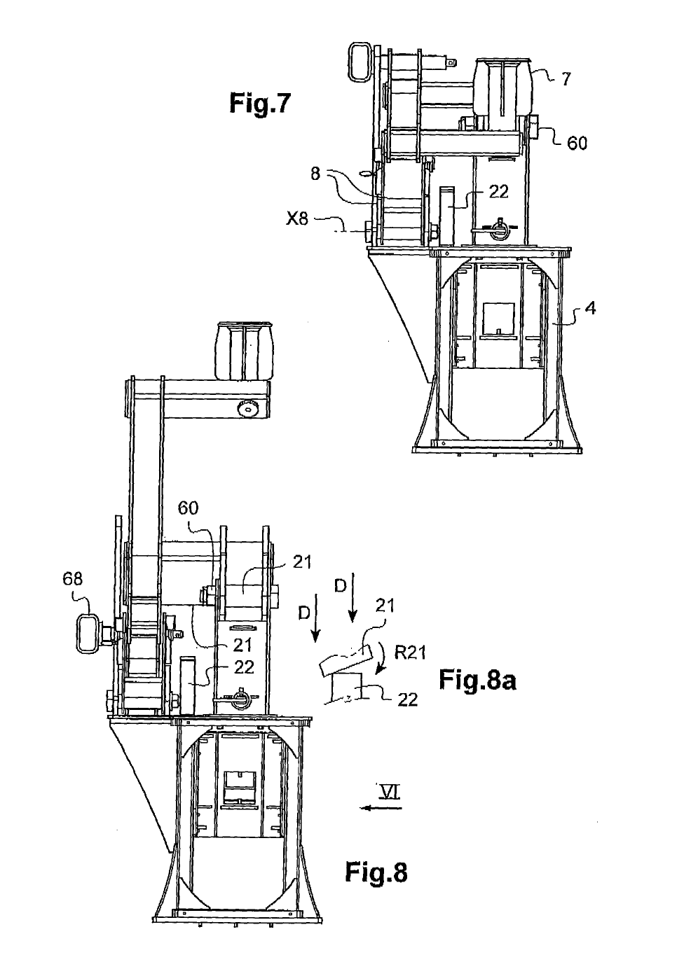

FIG. 7 is a front view, in the direction VII, of the column in FIG. 2, with the beam horizontal;

FIG. 8 is a front view, in the direction VII, of the column in FIG. 2, with the beam tilted;

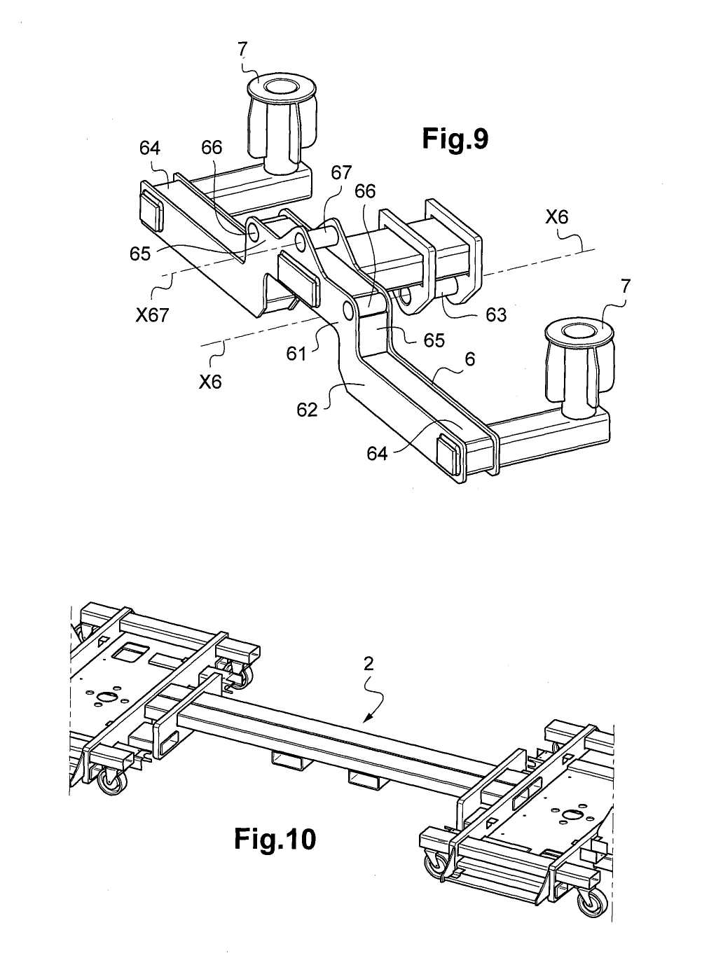

FIG. 9 depicts the beam of the previous figures, in isolation;

FIG. 10 depicts a support of the lorry type for the device of FIG. 1;

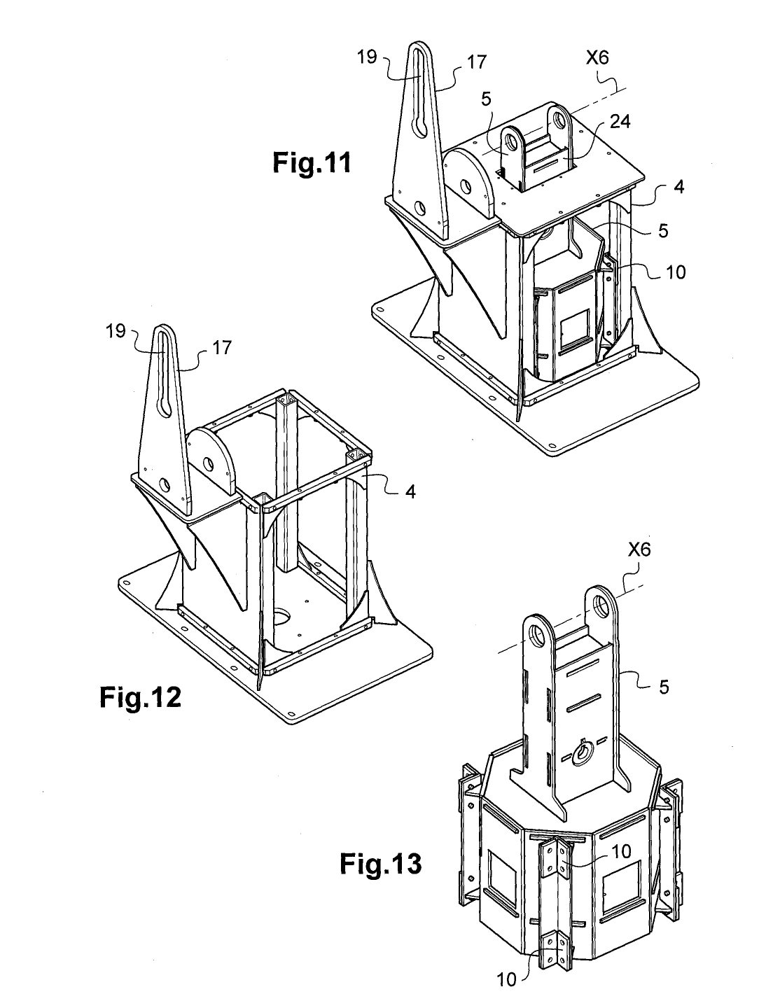

FIG. 11 depicts the fixed part and the movable part of the column of FIG. 2;

FIGS. 12 and 13 depict respectively the fixed part and the movable part of FIG. 11, in isolation;

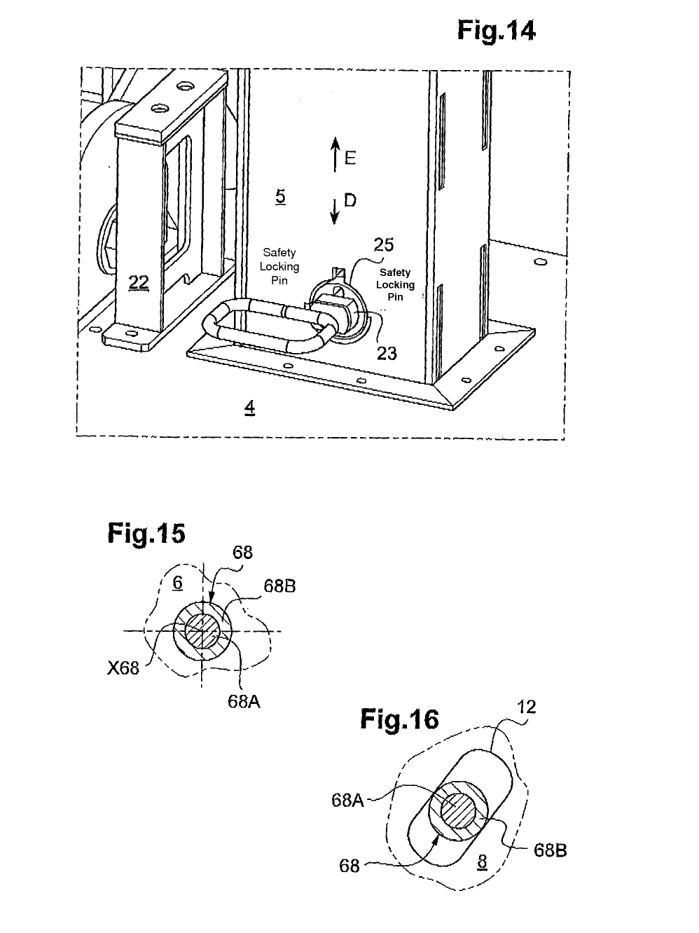

FIG. 14 illustrates a safety system for the device; and

FIGS. 15 and 16 are views in cross section, depicting a key in engagement with the beam and a link, respectively.

FIG. 1 illustrates a device 1 according to the invention for the lifting and tilting of a solid piece 100 to be turned. In the example illustrated, the device 1 comprises mainly a support 2 and two columns 3. In this example, the support 2 is of the lorry type, that is to say it consists of a chassis on wheels; the two columns rest on the chassis 2; the chassis connects the two columns 3 together.

Each column 3 comprises:
a movable part 5 sliding vertically in a fixed part 4, fixed relative to the chassis; the movable part being guided by shoes 10, which may be made from polyethylene;
a bellows jack 16, mounted under the movable part 5 inside the fixed part, which provides guidance thereof, this jack providing a vertical movement of the movable part relative to the fixed part 4;
a beam 6 mounted so as to pivot about a transverse pivot 60, with a pivot axis X6, fixed relative to the movable part 5; the axis X6 extends transversely to the device;
interface pieces 7 mounted at the distal ends of the beam to fit to the piece to be turned;
a device for adjusting the centre of gravity of the “piece +beam” assembly so that this centre of gravity is close to the axis X6, preferably below the axis X6;
at least one orientation link 8; in the example illustrated, it has two links 8;
a guide 17 for pure lifting E or descent D, that is to say without tilting, of the beam+piece assembly; said guide 17 rises substantially vertically from the fixed part 4, to which it is rigidly fixed. An oblong slot 19 is formed vertically in the guide 17.

In the example illustrated, the beam 6 consists essentially of a girder in the form of a Ω (the letter omega). This girder extends substantially from front to rear; as particularly illustrated in FIG. 9, this girder is formed by a raised central part 61, and two arms 62, lower than the central part 61, connected to the central part by shoulders 65 at their proximal ends. The central part carries a lateral protrusion forming a bearing 63 carrying the pivot axis X6, so that the pivot axis passes under the central part between the proximal ends of the arms 62. Each distal end 64 of each arm 62 carries a respective interface piece 7.

In the example illustrated, there are two links 8 rigidly connected together substantially at a right angle, in the form of a square 8,8. This square 8,8 is articulated close to the junction of the two links about a link axis X8 carried by the lifting guide 17. Each link 8 carries at its distal end, relative to the link axis X8, an aperture 12 designed to receive therein a key 68 (see FIG. 16).

A first tubular passage and a second tubular passage 66 are formed transversely, each at the junction of the central part 61 of the beam and a respective shoulder. Each first passage 66 is designed to be able to receive the key 68 therein.

A third tubular passage 67, of axis X67, is formed transversely in a top extension, extending vertically upwards from the central part 61. This third passage 67 is designed to receive a pin 18. The axis X67 of the third passage and the pivot axis X6 form a symmetry plane for the beam.

The functioning of the device 1 of the invention will now be described.

As particularly illustrated in FIGS. 3 and 4, the device 1 can function in pure lifting (or symmetrically in descent), the beam remaining horizontal. For this purpose, when no link 8 is fixed to the beam, the third passage 67 is placed opposite the oblong slot 19, and the pin 12 is inserted in both the passage and the slot. The pressurisation or depressurisation of the jack 16 causes the movable part 5 to slide in the fixed part 4 of the column 3. Simultaneously, the pressurisation or depressurisation of the jack 16 causes the pin 18, indirectly fixed to the movable part, to slide in the oblong slot 19, indirectly fixed to the fixed part. Guided by and captive in the oblong slot 19, which is vertical, the pine 18 prevents tilting of the beam 6; the beam therefore remains horizontal.

As particularly illustrated in FIGS. 5 and 6, the device 1 can allow the rotation R of the piece 100 to be treated. For this purpose, the beam being for example initially horizontal, one from among the first passage 66 and the second passage 66 is placed opposite an aperture 12 of a corresponding link 8. The key 68 is then inserted both in the passage 66 and in the aperture 12. Pressurisation of the jack 16 causes the movable part 5 to slide in the fixed part 4 of the column 3. Simultaneously, the pressurisation of the jack 16 causes the vertical movement of the pivot 60, the axis of which is fixed relative to the movable part. At the same time, the beam is held on one side by the link 8, itself held by the fixed part, where it is mounted for rotation about the link axis X8. Thus held, the beam adopts a position tilted to the same side as the link by which it is held. In the case illustrated in FIGS. 1, 5 and 6, the beam 6 is connected to the most rearward link 8, so that the piece 100 is tilted towards the rear and presents its underside to the operator, who is in front of the device.

The depressurisation of the jack causes a return of the beam to the horizontal and a reverse rotation of the piece 100.

In order compensate for any differences in stroke between the jack 16 of a column and that of the other column, and to prevent locking of the device, in particular during the descent D, each window 12 has play; in the example illustrated in the figures, in particular FIG. 16, the window 12 is a window slightly oblong in the direction of elongation of its respective link 8. The play in the apertures 12, and in particular the fact that they are advantageously oblong, makes it possible to avoid transmitting forces in the columns 3 when one of the movable parts 5 of one of the columns 3 does not move at the same speed as the movable part of the other column, for the time that the height differential is taken up.

The key 68 of the link, of axis X68, has a certain elasticity in order to prevent a hunting phenomenon. Thus, in the example illustrated, in particular in FIGS. 15 and 16, the key 68 consists of a metal cylindrical core 68A, embedded in an elastomer cylinder 68B. This configuration of the key 68 prevents the phenomenon of hunting and attenuates any jolts at the start of the lifting E.

As illustrated in FIGS. 8A and 14, an end-of-travel stop 22 is provided for the docking of a heel 21 of the beam 6, at the end of descent D.

In the example in FIG. 1, the pieces of the interface 7 are two girders, one connecting the front ends of the beam, the other the rear ends. The use of such girders 7, which are sufficiently rigid, limits the bending forces on the columns. In the other figures, the interface pieces 7 are four cylindrical pots, each at a respective end of the beams. In FIGS. 2 to 9, no piece to be turned is shown.

Each link 8 is advantageous equipped with at least one handle 11 in order to facilitate its positioning by an operator responsible for putting opposite each other a window 12 and the corresponding first passage 66.

Some safety devices are advantageously provided; in particular a safety key 23 can be provided so as to be inserted in a hole 25 in the movable part 5 in order to come into abutment on the fixed part 4, in the event of loss of pressure in the jacks 16 (see FIG. 14).

Naturally the invention is not limited to the preferred embodiments that have just been described, but on the contrary the invention is defined by the following claims.

It will appear in fact to a person skilled in the art that various modifications can be made to the embodiments described above, in the light of the teaching that has just been disclosed to him.

Thus, in particular, the support may advantageously be extensible, so that the separation between the two columns of the device is variable and can be adapted to a dimension of the piece to be turned.

Thus, rather than being mounted so as to be able to move on a support of the lorry type, the device can be mounted fixed, each column resting on and being fixed to the ground.

The use of bellows jacks is particularly advantageous. This is because:
such a jack does not comprise a rod;
guidance thereof is external;
the ratio between its height, folded, and its travel is very high; and
it does not comprise any sliding joint.

The drawbacks of such a jack:
stroke and force are dependent; and
tendency for hunting;
   remain minor compared with the advantages thereof, and are solved by the device described.

An orientation link, may be multi-position, which, by holding the beam laterally, causes its rotation R about its pivot axis, as it rises, or conversely as it descends, under the effect of the jacks.

A device according to the invention may comprise a return jack, in particular when the centre of gravity of the piece to be treated is highly off centre. The centre of gravity may be positioned so that the piece, and the beams, are returned by gravity into the horizontal position of the beams.

Though bellows jacks are particularly advantageous, in particular because of their small bulk, other types of jack may be used, in particular hydraulic, pneumatic or rack jacks.

Instead of the link being mounted removably on the beam, and permanently connected to the fixed part, it is possible to provide for each line to be mounted permanently on its respective arm and removably on the fixed part.

1. Turning device (1), in particular for a piece (100), characterised in that it comprises at least one tower (3), each tower comprising:
a fixed part (4) and a part (5) able to move vertically relative the fixed part;
jack means (16) for moving said movable part relative to said fixed part;
a beam (6) able to move about a fixed pivot axis (X6) relative to said movable part, said beam comprising at least one arm (62); and
means (8) for holding said arm, preferably in a releasable fashion, on the fixed part, at a distance horizontally from said pivot axis (X6);
said piece being fixed to said beams.

2. Device according to claim 1, characterised in that it comprises two towers (3), facing each other.

3. Device according to claim 1, characterised in that the jack means comprise a bellows jack (16).

4. Device according to claim 1, characterised in that each beam comprises two arms (62) extending substantially opposite each other and, preferably, holding means (8) particular to each arm.

5. Device according to claim 1; characterised in that the holding means comprise a link (8) articulated on the fixed part.

6. Device according to claim 5, characterised in that it comprises pin means (12, 66, 68) for connecting and articulating the link (8) removably with the corresponding arm (62).

7. Device according to claim 6, characterised in that the pin (68) comprises elastic means, preferably an elastomer cylinder (68B) surrounding a metal core (68A).

8. Device according to claim 1, characterised in that it comprises means (17, 18, 67) for moving the piece (100) in vertical translation, each arm (62) being released from the holding means (8).

9. Device according to claim 8, characterised in that it comprises a guide (17) and means (18) of engagement between the beam (6) and said guide at a distance from the pivot axis (X6), said guide comprising an oblong window (19) for the vertical guidance of said engagement means.

10. Device according to claim 2, characterised in that the jack means comprise a bellows jack (16).

11. Device according to claim 2, characterised in that each beam comprises two arms (62) extending substantially opposite each other and, preferably, holding means (8) particular to each arm.

12. Device according to claim 2, characterised in that the holding means comprise a link (8) articulated on the fixed part.

13. Device according to claim 2, characterised in that it comprises pin means (12, 66, 68) for connecting and articulating the link (8) removably with the corresponding arm (62).

14. Device according to claim 2, characterised in that it comprises means (17, 18, 67) for moving the piece (100) in vertical translation, each arm (62) being released from the holding means (8).
